(19) United States
(12) Patent Application Publication
(10) Pub. No.: US 2008/0123002 A1
(43) Pub. Date: May 29, 2008

(54) Liquid crystal display and driving method thereof

(75) Inventor: Shin-Hung Yeh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/998,052

(22) Filed: Nov. 27, 2007

(30) Foreign Application Priority Data
Nov. 27, 2006 (TW) 95143789

(51) Int. Cl. G02F 1/1333; G02F 1/133; G02F 1/1368; G09G 3/36

(52) U.S. Cl. 349/37; 349/33; 349/48; 349/38

(57) ABSTRACT

An exemplary a liquid crystal display includes a plurality of scanning lines and control lines, a plurality of first pixel units and second pixel units, and a data line driving chip. The first and second pixel units are connected to be under control of the scanning lines and the control lines. The data line driving chip includes a plurality of output terminals. During a period when one of the scanning lines is scanned, the corresponding first and second pixel units are able to receive a first gradation voltage signal output from the output terminals, and subsequently only the corresponding second pixel units are able to receive a second gradation voltage signal output from the output terminals. A method of driving such kind of liquid crystal display is also provided.

### FIELD OF THE INVENTION

The present invention relates to a liquid crystal display (LCD) requiring relatively few data lines, and a method for driving the liquid crystal display.

### BACKGROUND

Because liquid crystal displays have the advantages of portability, low power consumption, and low radiation, they have been widely used in various portable information products such as notebooks, personal digital assistants (PDAs), video cameras, and the like. Furthermore, liquid crystal displays are considered by many to have the potential to completely replace cathode ray tube (CRT) monitors and televisions.

FIG. 7 is an abbreviated circuit diagram of a typical liquid crystal display 10. The liquid crystal display 10 includes a liquid crystal panel (not labeled), a plurality of data line driving chips 110, and a plurality of scanning line driving chips 112. The liquid crystal panel includes a first glass substrate (not shown), a second glass substrate (not shown) parallel to the first substrate (not shown), and a liquid crystal layer (not shown) sandwiched between the first and second substrates.

The first substrate includes a number of scanning lines 142 that are parallel to each other and that each extend along a first direction, and a number of data lines 141 that are parallel to each other and that each extend along a second direction orthogonal to the first direction. The scanning lines 142 and the data lines 141 form a crisscross pattern. The first substrate also includes a plurality of thin film transistors (TFTs) 101 that function as switching elements. The first substrate further includes a plurality of pixel electrodes 102 formed on a surface thereof facing toward the second substrate. Each TFT 101 is provided in the vicinity of a respective point of intersection of the data lines 141 and the scanning lines 142.

Each TFT 101 includes a gate electrode (not labeled), a source electrode (not labeled), and a drain electrode (not labeled). The gate electrode of the TFT 101 is connected to the corresponding scanning line 142. The source electrode of the TFT 101 is connected to the corresponding data line 141. The drain electrode of the TFT 101 is connected to a corresponding pixel electrode 102.

The second substrate includes a plurality of common electrodes 103 generally opposite to the pixel electrodes 102. In particular, the common electrodes 103 are formed on a surface of the second substrate that faces toward the first substrate. One pixel electrode 102, one common electrode 103 facing toward the pixel electrode 102, and liquid crystal molecules of the liquid crystal layer between the two electrodes 102, 103 cooperatively define a liquid crystal capacitor (not labeled). One pixel electrode 102, one common electrode 103 facing toward the pixel electrode 102, and an insulated layer (not shown) between the two electrodes 102, 103 cooperatively define a storage capacitor 104. One TFT 101, one corresponding liquid crystal capacitor, and one corresponding storage capacitor 104 cooperatively define a pixel unit 106.

The scanning lines 142 are connected to the scanning line driving chips 112. The data lines 141 are connected to the data line driving chips 110; and each data line driving chip 110 includes a plurality of output terminals 111 respectively connected to the data lines 141.

In the above-described liquid crystal display 10, each output terminal 111 of each data line driving chip 110 can only drive the pixel units 106 of a single column. Because the number of pixel units 106 of the liquid crystal panel is typically huge, a large number of data line driving chips 110 are needed to drive all the pixel units 106. Thus, a cost of manufacturing the liquid crystal display 10 is correspondingly high.

What is needed, therefore, is a liquid crystal display that can circumvent, overcome or at least mitigate the above-described difficulties. What is also needed is a method of driving such kind of liquid crystal display.

### SUMMARY

In one preferred embodiment, a liquid crystal display includes a plurality of scanning lines and control lines, a plurality of first pixel units and second pixel units, and a data line driving chip. The first and second pixel units are connected to be under control of the scanning lines and the control lines. The data line driving chip includes a plurality of output terminals. During a period when one of the scanning lines is scanned, the corresponding first and second pixel units are able to receive a first gradation voltage signal output from the output terminals, and subsequently only the corresponding second pixel units are able to receive a second gradation voltage signal output from the output terminals. A method of driving such kind of liquid crystal display is also provided.

Other aspects, novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an abbreviated circuit diagram of a liquid crystal display according to a first embodiment of the present invention.

FIG. 2 is an abbreviated timing chart illustrating operation of the liquid crystal display of FIG. 1.

FIG. 3 is a schematic view of some pixel units of the liquid crystal display of FIG. 1, showing a row inversion driving method of the liquid crystal display.

FIG. 4 is similar to FIG. 3, but showing a dot inversion driving method of the liquid crystal display.

FIG. 5 is an abbreviated circuit diagram of a liquid crystal display according to a second embodiment of the present invention.

FIG. 6 is a schematic view of some pixel units of the liquid crystal display of FIG. 5, showing a two-row inversion driving method of the liquid crystal display.

FIG. 7 is an abbreviated circuit diagram of a conventional liquid crystal display.

### DETAILED DESCRIPTION OF PREFERRED EMBODIMENTS

Reference will now be made to the drawings to describe various embodiments of the present invention in detail.

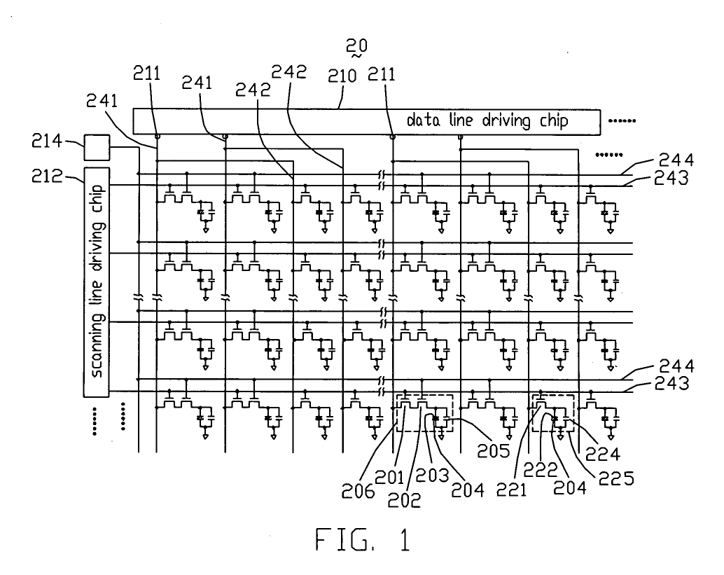

In FIG. 1, a liquid crystal display 20 according to a first embodiment of the present invention includes a liquid crystal panel (not labeled), a plurality of data line driving chips 210, a plurality of scanning line driving chips 212, and a signal generator 214. The liquid crystal panel includes a first glass substrate (not shown), a second glass substrate (not shown) parallel to the first substrate (not shown), and a liquid crystal layer (not shown) sandwiched between the first and second substrates. In the illustrated embodiment, the liquid crystal panel is a twisted-nematic (TN) type liquid crystal panel.

The first substrate includes a number of scanning lines 243 and control lines 244 that are parallel to each other and that each extend along a first direction, and a number of first data lines 241 and second data lines 242 that are parallel to each other and that each extend along a second direction orthogonal to the first direction. The scanning lines 243 and the first data lines 241 form a crisscross pattern. The first substrate also includes a plurality of first TFTs 201, second TFTs 202, and third TFTs 221 that function as switching elements. The first substrate further includes a plurality of first pixel electrodes 203 and second pixel electrodes 222 formed on a surface thereof facing toward the second substrate.

Each of the first, second, and third TFTs 201, 202, 221 includes a gate electrode (not labeled), a source electrode (not labeled), and a drain electrode (not labeled). The gate electrode of the first TFT 201 is connected to the corresponding scanning line 243. The source electrode of the first TFT 201 is connected to the corresponding first data line 241. The drain electrode of the first TFT 201 is connected to the source electrode of the second TFT 202. The gate electrode of the second TFT 202 is connected to the corresponding control line 244. The drain electrode of the second TFT 202 is connected to the corresponding first pixel electrode 203.

The second substrate includes a plurality of common electrodes 204 generally opposite to the first and second pixel electrodes 203, 222. In particular, the common electrodes 204 are formed on a surface of the second substrate that faces toward the first substrate, and are made from a transparent material such as Indium-Tin Oxide (ITO) or the like. One first pixel electrode 203, one common electrode 204 facing toward the first pixel electrode 203, and liquid crystal molecules of the liquid crystal layer between the two electrodes 203, 204 cooperatively define a first liquid crystal capacitor (not labeled). One first pixel electrode 203, one common electrode 204 facing toward the first pixel electrode 203, and an insulated layer (not shown) between the two electrodes 203, 204 cooperatively define a first storage capacitor 205. One first TFT 201, one second TFT 202, one first liquid crystal capacitor, and one first storage capacitor 205 cooperatively define a first pixel unit 206. The first pixel units 206 are arranged in parallel columns.

The gate electrode of the third TFT 221 is connected to the corresponding scanning line 243. The source electrode of the third TFT 221 is connected to the corresponding second data line 242. The drain electrode of the third TFT 221 is connected to the corresponding second pixel electrode 222. One second pixel electrode 222, one common electrode 204, and liquid crystal molecules of the liquid crystal layer between the two electrodes 222, 204 cooperatively define a second liquid crystal capacitor (not labeled). One second pixel electrode 222, one common electrode 204 facing toward the second pixel electrode 222, and an insulated layer (not shown) between the two electrodes 222, 204 cooperatively define a second storage capacitor 224. The second storage capacitor 224 is connected to the corresponding second liquid crystal capacitor in parallel. One third TFT 221, one second liquid crystal capacitor, and one second storage capacitor 224 cooperatively define a second pixel unit 225. The second pixel units 225 are arranged in parallel columns. Each two adjacent first pixel units 206 are adjacent to two adjacent second pixel units 225 in a same row of the pixel units 206, 225. That is, pairs of first pixel units 206 and pairs of second pixel units 225 are alternately arranged along a same row of the pixel units 206, 225. 100261 The control lines 244 are connected to the signal generator 214. The scanning lines 243 are connected to the scanning line driving chips 212. The data line driving chips 210 include a plurality of output terminals 211. Each output terminal 211 is connected to one first data line 241 and one second data line 242.

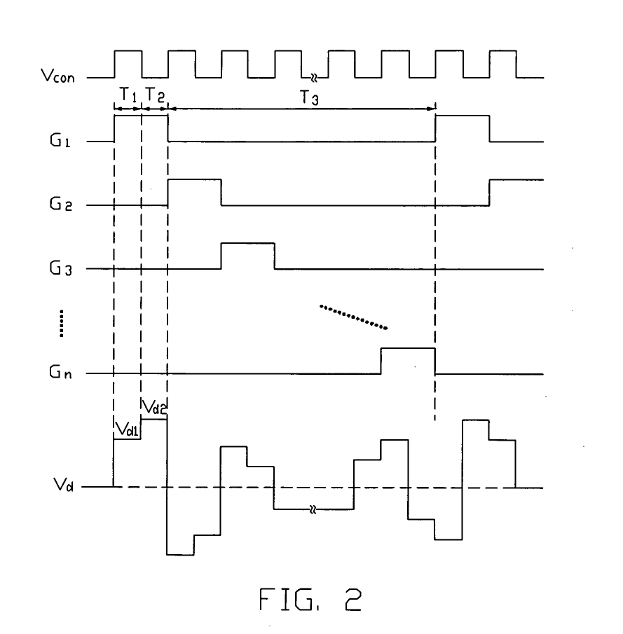

FIG. 2 is an abbreviated timing chart illustrating operation of the liquid crystal display 20. Each frame is divided into a first period T1, a second period T2, and a third period T3. During the first period T1, a high voltage control signal is generated by the signal generator 214, and is applied to the control lines 244 to turn on the second TFTs 202 connected thereto. At the same time, a high voltage scanning signal is generated by the scanning line driving chip 212, and is applied to the scanning line 243 of a first row to turn on the first and third TFTs 201, 221 connected thereto. A first gradation voltage signal V_{d1} is generated by the data line driving chip 210, and is applied to the first and second data lines 241, 242. In each first pixel unit 206 of the first row connected to the corresponding first data line 241, the first gradation voltage signal V_{d1} is sequentially applied to the first pixel electrode 203 via the source and drain electrodes of the first TFT 201 and the source and drain electrodes of the second TFT 202; and in each second pixel unit 225 of the first row connected to the corresponding second data line 242, the first gradation voltage signal V_{d1} is sequentially applied to the second electrode 222 via the source and drain electrodes of the third TFT 221. Therefore, the first pixel units 206 connected to the scanning line 243 of the first row can display corresponding image data, and the second pixel units 225 connected to the scanning line 243 can display image data corresponding to that of the first pixel units 206. At the same time, the first and second storage capacitors 205, 224 are charged to store the first gradation voltage signal V_{d1}.

During the second period T2, a low voltage control signal is generated by the signal generator 214, and is applied to the control lines 244 to turn off the second TFTs 202 connected thereto. At the same time, the first pixel units 206 display the image data corresponding to the first gradation voltage signal V_{d1} provided by the first storage capacitor 205. The first and third TFTs 201, 221 connected to the scanning line 243 are still turned on because of the high voltage scanning signal applied thereto. A second gradation voltage signal V_{d2} is generated by the data line driving chip 210, and is applied to the first and second data lines 241, 242. Because the second TFTs 202 connected to the control line 244 are turned off, the second gradation voltage signal V_{d2} is unable to be applied to the first pixel electrode 203, but is applied to the second pixel electrode 222 via the source and drain electrodes of the third TFT 221. Thus, the second pixel units 225 connected to the scanning line 243 can display corresponding image data. The second storage capacitors 224 are charged to store the second gradation voltage signal V_{d2}. In the illustrated embodiment, the first period T1 is equal to the second period T2. In alternative embodiments, the first period T1 can be greater than the second period T2, or the first period T1 can be less than the second period T2.

During the third period T3, a low voltage scanning signal is generated by the scanning line driving chip 212, and is applied to the scanning line 243 to turn off the second TFTs 202 connected thereto. The first pixel units 206 display the image data corresponding to the first gradation voltage signal V_{d1} provided by the first storage capacitors 205. The second pixel units 225 display the image data corresponding to the second gradation voltage signal V_{d2} provided by the second storage capacitors 224.

In a subsequent frame, the scanning line 243 is scanned by scanning signals generated by the scanning line driving chip 212 again, and the scanning line 243 of a second row is similarly scanned. The first pixel units 206 connected to the scanning line 243 display the image data corresponding to the first gradation voltage signal V_{d1} provided by the first storage capacitor 205, and the second pixel units 225 connected to the scanning line 243 also display the image data corresponding to the second gradation voltage signal V_{d2} provided by the second storage capacitors 224.

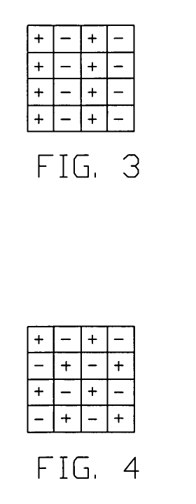

If a polarity of the first gradation voltage signal V_{d1} is different from that of the second gradation voltage signal V_{d2}, a variation between the voltage signals V_{d1}, V_{d2} applied to the second pixel electrodes 222 in a single frame may be unduly great, which is liable to result in inaccurate displays of the image data by the second pixel units 225. Therefore, the liquid crystal display 20 can use a row inversion driving method as shown in FIG. 3, or a dot inversion driving method as shown in FIG. 4. By using the row inversion driving method or the dot inversion driving method, the polarities of the first and second gradation voltage signals V_{d1}, V_{d2} are the same. That is, the polarities of the voltage signals applied to the first and second pixel units 206, 225 connected to the same output terminal 211 are the same. Thus, the first and second pixel units 206, 225 can achieve accurate displays of image data.

In summary, each output terminal 211 of the data line driving chip 210 can drive the first and second pixel units 206, 225 in two columns. Thus, the number of output terminals 211 can be approximately half the number of output terminals 111 of the above-described conventional data line driving chip 110. Therefore, the number of data line driving chips 210 can be reduced, and a cost of manufacturing the liquid crystal display 20 is correspondingly reduced.

In an alternative embodiment, the liquid crystal panel can be replaced with an in-plane-switching (IPS) panel. Common electrodes and pixel electrodes are formed at a same one of two substrates of the IPS panel.

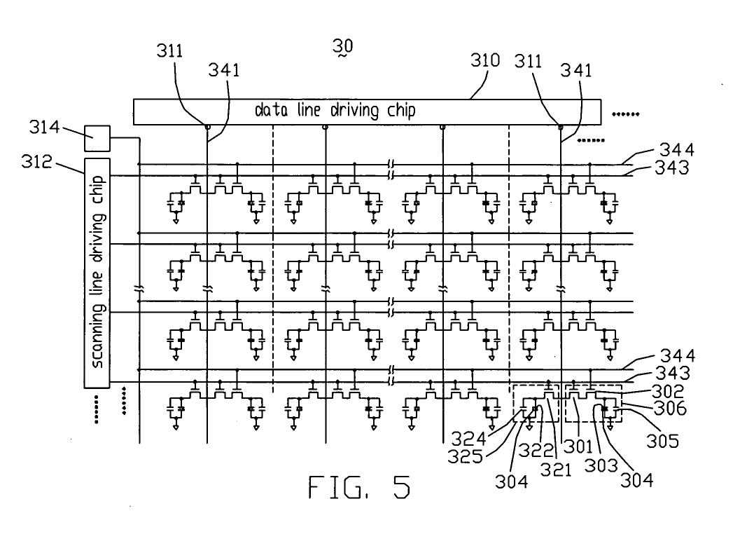

In FIG. 5, a liquid crystal display 30 according to a second embodiment of the present invention includes a liquid crystal panel (not labeled), a plurality of data line driving chips 310, a plurality of scanning line driving chips 312, and a signal generator 314. The liquid crystal panel includes a first glass substrate (not shown), a second glass substrate (not shown) parallel to the first substrate (not shown), and a liquid crystal layer (not shown) sandwiched between the first and second substrates. In the illustrated embodiment, the liquid crystal panel is a TN type liquid crystal panel.

The first substrate includes a number of scanning lines 343 and control lines 344 that are parallel to each other and that each extend along a first direction, and a number of data lines 341 that are parallel to each other and that each extend along a second direction orthogonal to the first direction. The scanning lines 343 and the data lines 341 form a crisscross pattern. The first substrate also includes a plurality of first TFTs 301, second TFTs 302, and third TFTs 321 that function as switching elements. The first substrate further includes a plurality of first pixel electrodes 303 and second pixel electrodes 322 formed on a surface thereof facing toward the second substrate.

Each of the first, second, and third TFTs 301, 302, 321 includes a gate electrode (not labeled), a source electrode (not labeled), and a drain electrode (not labeled). The gate electrode of the first TFT 301 is connected to the corresponding scanning line 343. The source electrode of the first TFT 301 is connected to the corresponding data line 341. The drain electrode of the first TFT 301 is connected to the source electrode of the second TFT 302. The gate electrode of the second TFT 302 is connected to the corresponding control line 344. The drain electrode of the second TFT 302 is connected to the corresponding first pixel electrode 303.

The second substrate includes a plurality of common electrodes 304 generally opposite to the first and second pixel electrodes 303, 322. In particular, the common electrodes 304 are formed on a surface of the second substrate that faces toward the first substrate, and are made from a transparent material such as ITO or the like. One first pixel electrode 303, one common electrode 304 facing toward the first pixel electrode 303, and liquid crystal molecules of the liquid crystal layer between the two electrodes 303, 304 cooperatively define a first liquid crystal capacitor (not labeled). One first pixel electrode 303, one common electrode 304 facing toward the first pixel electrode 303, and an insulated layer (not shown) between the two electrodes 303, 304 cooperatively define a first storage capacitor 305. One first TFT 301, one second TFT 302, one first liquid crystal capacitor, and one first storage capacitor 305 cooperatively define a first pixel unit 306. The first pixel units 306 are arranged in parallel columns.

The gate electrode of the third TFT 321 is connected to the corresponding scanning line 343. The source electrode of the third TFT 321 is connected to the corresponding second pixel electrode 322. The drain electrode of the third TFT 321 is connected to the corresponding source electrode of the first TFT 301. One second pixel electrode 322, one common electrode 304, and liquid crystal molecules of the liquid crystal layer between the two electrodes 322, 304 cooperatively define a second liquid crystal capacitor (not labeled). One second pixel electrode 322, one common electrode 304 facing toward the second pixel electrode 322, and an insulated layer (not shown) between the two electrodes 322, 304 cooperatively define a second storage capacitor 324. The second storage capacitor 324 is connected to the corresponding second liquid crystal capacitor in parallel. One third TFT 321, one second liquid crystal capacitor, and one second storage capacitor 324 cooperatively define a second pixel unit 325. The second pixel units 325 are arranged in parallel columns. Each first pixel unit 306 is adjacent to one corresponding second pixel unit 325 in a same row of the pixel units 306, 325.

The control lines 344 are connected to the signal generator 314. The scanning lines 343 are connected to the scanning line driving chips 312. The data line driving chips 310 include a plurality of output terminals 311. Each output terminal 311 is connected to one data line 341.

A typical example of operation of the liquid crystal display 30 includes the following. Each frame is divided into a first period, a second period next to the first period, and a third period next to the second period. During the first period, a high voltage scanning signal generated by the scanning line driving chip 312 is applied to the scanning line 343, and the first and third TFTs 301, 321 connected to the scanning line 343 are turned on. At the same time, the second TFTs 302 connected to the control line 344 are turned on. A first gradation voltage signal V_{d1} is generated by the data line driving chip 310, and is applied to the first and second pixel electrodes 303, 322. Therefore the first and second pixel units 306, 325 display the same image data, and the first and second storage capacitors 305, 324 are charged to store the first gradation voltage signal V_{d1}.

During the second period when the high voltage scanning signal generated by the scanning line driving chip 312 is applied to the scanning line 343, the first and third TFTs 301, 321 connected to the scanning line 343 are still turned on. At the same time, the second TFTs 302 connected to the control line 344 are turned off. A second gradation voltage signal V_{d2} is generated by the data line driving chips 310, and is only applied to the second pixel electrodes 322 via the data lines 341. Therefore the second pixel units 325 maintain displaying corresponding image data, and the first storage capacitors 305 are charged to store the second gradation voltage signal V_{d2}. The first pixel units 306 display the image data corresponding to the first gradation voltage signal V_{d1} provided by the first storage capacitors 305.

During the third period when a low voltage scanning signal generated by the scanning line driving chip 312 is applied to the scanning line 343, the first pixel units 306 maintain displaying the image data corresponding to the first gradation voltage signal V_{d1} provided by the first storage capacitors 305, and the second pixel units 325 maintain displaying the image data corresponding to the second gradation voltage signal V_{d2} provided by the second storage capacitors 324.

In a subsequent frame, the scanning line 343 is similarly scanned by scanning signals generated by the scanning line driving chip 312 again. The first pixel units 306 still display the image data corresponding to the first gradation voltage signal V_{d1} provided by the first storage capacitors 305, and the second pixel units 325 also display the image data corresponding to the second gradation voltage signal V_{d2} provided by the second storage capacitors 324.

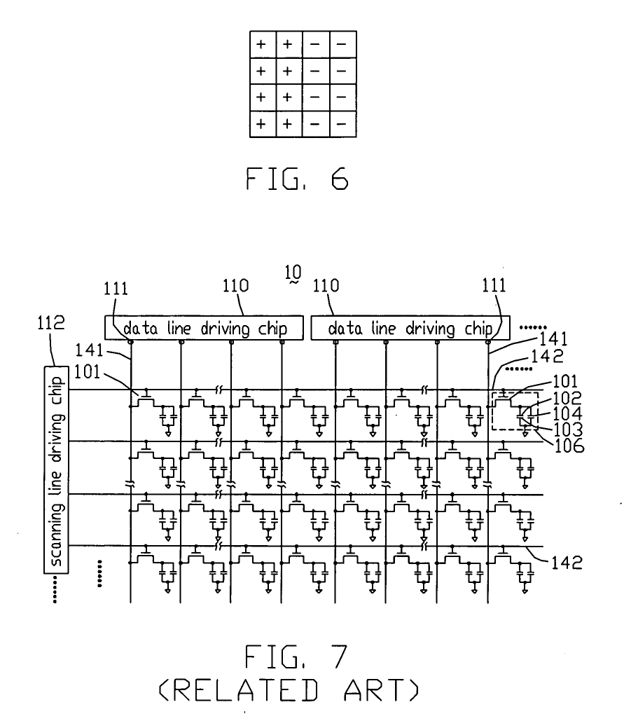

Similar to the above-described liquid crystal display 20, the liquid crystal display 30 can use a two-row inversion driving method as shown in FIG. 6 to achieve accurate displays.

In summary, each output terminal 311 of the data line driving chip 310 can drive the first and second pixel unit 306, 325 in two columns. Thus, the number of the output terminals 311 can be approximately half the number of the output terminals 111 of the above-described conventional data line driving chip 110. Therefore, the number of data line driving chips 310 can be reduced, and a cost of manufacturing the liquid crystal display 30 is correspondingly reduced. Furthermore, the necessary data lines 341 are also reduced by half the amount of the data lines 141 of the above-described conventional liquid crystal display 10. Thus a layout of the liquid crystal panel of the liquid crystal display 30 is simplified.

In an alternative embodiment, the liquid crystal panel can be replaced with an IPS panel. Common electrodes and pixel electrodes are formed at a same one of two substrates of the IPS panel.

Further or alternative embodiments may include the following. In one example, the control lines 244 can be directly connected to the scanning line driving chips 212. Therefore the scanning voltage signals can be generated by the scanning line driving chips 212, and are applied to the control lines 244 when the scanning line driving chips 212 drive the scanning lines 243.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A liquid crystal display comprising:
a plurality of scanning lines and control lines;
a plurality of first pixel units and second pixel units, the first and second pixel units being connected to be under control of the scanning lines and the control lines; and
a data line driving chip comprising a plurality of output terminals;
wherein during a period when one of the scanning lines is scanned, the corresponding first and second pixel units are able to receive a first gradation voltage signal output from the output terminals, and subsequently only the corresponding second pixel units are able to receive a second gradation voltage signal output from the output terminals.

2. The liquid crystal display as claimed in claim 1, further comprising a plurality of first data lines and second data lines, wherein the first and second data lines are connected to the output terminals, each output terminal applies the first gradation voltage signal to the first pixel units via the corresponding first data line, and applies the first and second gradation voltage signals to the second pixel units via the corresponding second data line.

3. The liquid crystal display as claimed in claim 2, wherein each first pixel unit comprises a first thin film transistor (TFT), a second TFT, and a first pixel electrode, a gate electrode of the first TFT being connected to the corresponding scanning line, a source electrode of the first TFT being connected to the corresponding first data line, a drain electrode of the first TFT being connected to a source electrode of the second TFT, a gate electrode of the second TFT is connected to the corresponding control line, a drain electrode of the second TFT is connected to the first pixel electrode, when the scanning line being scanned, the first TFT being turned on, the second TFT being turned on or turned off via the control line to determine whether applying the first and/or second gradation voltage signal to the first pixel electrode.

4. The liquid crystal display as claimed in claim 3, wherein the second pixel comprises a third TFT and a second pixel electrode, a gate electrode of the third TFT being connected to the corresponding scanning line, a source electrode of the third TFT being connected to the second data line, a drain electrode of the third TFT being connected to the second pixel electrode, when the scanning line being scanned, the third TFT being turned on, the first and/or second gradation voltage signal being applied to the second pixel electrode via the second data line.

5. The liquid crystal display as claimed in claim 2, wherein the liquid crystal display uses a row inversion driving method or a dot inversion driving method.

6. The liquid crystal display as claimed in claim 4, further comprising a plurality of common electrodes, wherein one first pixel electrode, one common electrode facing toward the first pixel electrode, and liquid crystal molecules between the first pixel electrode and the common electrode cooperatively define a first liquid crystal capacitor, one second pixel electrode, one common electrode, and liquid crystal molecules between the second pixel electrode and the common electrode cooperatively define a second liquid crystal capacitor.

7. The liquid crystal display as claimed in claim 6, further comprising a plurality of first storage capacitors and second storage capacitors, wherein the first storage capacitors are connected to the first liquid crystal capacitors in parallel, and the second storage capacitors are connected to the second liquid crystal capacitors in parallel.

8. The liquid crystal display as claimed in claim 2, wherein pairs of first pixel units and pairs of second pixel units are alternately arranged along a same row of the first and second pixel units.

9. The liquid crystal display as claimed in claim 1, further comprising a plurality of data lines, wherein the first and second pixel units are connected to the data lines, each output terminal being connected to one corresponding data line and applying the first and/or second gradation voltage signal to the corresponding first and second pixel units via the data line.

10. The liquid crystal display as claimed in claim 9, wherein each first pixel unit comprises a first TFT, a second TFT, and a first pixel electrode, a gate electrode of the first TFT being connected to the corresponding scanning line, a source electrode of the first TFT being connected to the corresponding data line, a drain electrode of the first TFT being connected to a source electrode of the second TFT, a gate electrode of the second TFT is connected to the corresponding control line, a drain electrode of the second TFT is connected to the first pixel electrode, when the scanning line being scanned, the first TFT being turned on, the second TFT being turned on or turned off via the control line to determine whether applying the first and/or second gradation voltage signal to the first pixel electrode.

11. The liquid crystal display as claimed in claim 10, wherein the second pixel comprises a third TFT and a second pixel electrode, a gate electrode of the third TFT being connected to the corresponding scanning line, a source electrode of the third TFT being connected to the corresponding second pixel electrode, a drain electrode of the third TFT being connected to the corresponding source electrode of the first TFT, when the scanning line being scanned, the third TFT being turned on, the first and/or second gradation voltage signal being applied to the second pixel electrode via the corresponding data line.

12. The liquid crystal display as claimed in claim 11, further comprising a plurality of common electrodes, wherein one first pixel electrode, one common electrode facing the first pixel electrode, and liquid crystal molecules between the first pixel electrode and the common electrode cooperatively define a first liquid crystal capacitor, one second pixel electrode, one common electrode, and liquid crystal molecules between the second pixel electrode and the common electrode cooperatively define a second liquid crystal capacitor.

13. The liquid crystal display as claimed in claim 12, further comprising a plurality of first storage capacitors and second storage capacitors, wherein the first storage capacitors are connected to the first liquid crystal capacitors in parallel, and the second storage capacitors are connected to the second liquid crystal capacitors in parallel.

14. The liquid crystal display as claimed in claim 9, wherein each first pixel unit is adjacent to one corresponding second pixel unit in a same row of the first and second pixel units.

15. The liquid crystal display as claimed in claim 9, wherein the liquid crystal display uses a two-row inversion driving method.

16. The liquid crystal display as claimed in claim 1, further comprising a signal generator configured for driving the control lines.

17. The liquid crystal display as claimed in claim 1, further comprising a scanning line driving chip configured for scanning the scanning lines.

18. The liquid crystal display as claimed in claim 1, wherein the first pixel units are arranged in parallel columns, and the second pixel units are arranged in parallel columns.

19. A method of driving the liquid crystal display in claim 1, the method comprising:
during a period when one of the scanning lines is scanned, the corresponding first and second pixel units receiving a first gradation voltage signal output from the output terminal; and
during a subsequent period when the scanning line is scanned, only the corresponding second pixel units receiving a second gradation voltage signal output from the output terminal.

20. A liquid crystal display comprising:
a liquid crystal panel comprising:
a plurality of scanning lines that are parallel to each other and that each extend along a first direction;
a plurality of control lines that are parallel to each other and that each extend along a second direction orthogonal to the first direction;
a plurality of output terminals configured for outputting gradation voltage signals;
a plurality of first pixel units connected to the scanning lines and the control lines, each of groups of the first pixel units being configured to receive the gradation voltage signals output from the output terminals during a period when the corresponding scanning line is scanned, and not receive the gradation voltage signals output from the output terminals during a subsequent period when the corresponding scanning line is scanned; and
a plurality of second pixel units connected to the scanning lines, each of groups of the second pixel units being configured to receive the gradation voltage signals output from the output terminals during the period when the corresponding scanning line is scanned and during the subsequent period when the corresponding scanning line is scanned;
a scanning line driving chip configured for scanning the scanning lines; and
a signal generator configured for driving the control lines.
